(19) United States
(12) Patent Application Publication
(10) Pub. No.: US 2008/0256035 A1
(43) Pub. Date: Oct. 16, 2008

(54) QUERY SUBSTITUTION USING ACTIVE LEARNING

(76) Inventors: Wei Vivian Zhang, Glendal, CA (US); Xiaofei He, Burbank, CA (US)

Correspondence Address: YAHOO! INC.;C/O DREIER LLP, 499 PARK AVENUE, NEW YORK, NY, 10022, US

(21) Appl. No.: 11/733,652

(22) Filed: Apr. 10, 2007

(51) Int. Cl. G06F 17/30

(52) U.S. Cl. 707/3

(57) ABSTRACT

The present invention is directed towards systems and methods for generating a linear regression model based on statistically frequent query pairs. The method of the present invention comprises storing statistically frequent query pairs, the query pairs constituting a query and a query rewrite. Query pair samples are generated based on the statistically frequent query pairs and an active learning algorithm is utilized to select the most informative query pairs. A linear regression algorithm is then utilized to generate a linear regression model based on the selected most informative query pairs.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to generating new queries which better describe a user search query. More specifically, the present invention is directed to systems and methods for generating a new query that is related to an original search query.

### BACKGROUND OF THE INVENTION

As the popularity of the Internet and World Wide Web grows, sponsored search marketing has become a vital part of any online business. The global nature of the World Wide Web has created a new market of advertising and the advancement of search engines has provided a suitable framework for targeted advertising. Advertisers are eager to place their advertisements on search engine results pages as the advertisements are targeted towards specific user searches, which has proven to be an effective advertising medium. Similarly, search engines are eager to place advertisements on search result pages as the advertisements generate revenue for the search engines themselves (e.g., pay-per-click advertising).

Sponsored search marketing allows an advertiser to place bids on keywords for which a user may search. For example, Gibson USA may decide they would like to advertise an SG-3 guitar to all users searching for the keyword “electric guitar”. Accordingly, an advertiser may submit a bid of one dollar per user click, that is, Gibson USA agrees to pay one dollar for every instance a user clicks on a hyperlink within an advertisement served by the search engine. Thus, when a user searches for the term “electric guitar” the search engine may return the search results along with an advertisement placed on the results page.

A major pitfall in sponsored search marketing, however, is the inherent difference between the number of permutations of user queries and the limited capacity of a keyword database. The number of permutations of user search queries is only limited by the input device used by the search engine (e.g., an HTML text box), which is often left as unlimited. Additionally, user queries may contain alternative constructs for terms already existing in the keyword storage. For example, a user may search for the query “cat carrier” which may not exist within a keyword data store. However, the term “feline carrier” may be located within the keyword data store and may contain relevant advertisements associated therewith.

This is obviously an unwanted aspect of sponsored search marketing from both the advertiser and search engine perspective, as advertisements are not shown and revenue not generated. Previous techniques to solve this deficiency have been to generate related new queries which can better describe the information need of a user and increase the chances of matching the new queries against the keyword data store (that contains bided keywords). These techniques have shown that the relevance between two queries can be machine learned through the use of a set of pre-labeled training examples (e.g., query pairs), the training examples being randomly selected. The process of labeling training examples is labor-intensive and involves consuming time to label irrelevant training examples.

Embodiments of the proposed invention cure the deficiencies of prior art methods by utilizing an active learning algorithm for selecting the most informative training examples from a large pool of query pairs. The most informative examples are then labeled and used to train a regression model to predict the relevance of an unlabeled query pair. Embodiments of the present invention provide many advantages over prior solutions including decreasing the number of training examples to be labeled to achieve good performance (reducing human-labeling work, which is a bottleneck in model development). The present invention may also be utilized for keyword suggestion, for selection of web advertisements, sponsored search and for model training of a general model search, thus providing a dynamic and robust solution.

### SUMMARY OF THE INVENTION

The present invention is directed towards methods and systems for generating a linear regression model based on statistically frequent query pairs. The method of the present invention comprises storing statistically frequent query pairs, the query pairs constituting a query and a query rewrite. In a preferred embodiment, the query pairs may be generated from a log of accumulated user queries. Additionally, storing statistically frequent query pairs may be based on determining if a query pair is above a log-likelihood threshold.

Query pair samples are then generated based on the statistically frequent query pairs. In a preferred embodiment generating query pair samples comprises selecting a predetermined amount of queries from a query log and locating the associated rewrites within stored statistically frequent query pairs. In an alternative embodiment, generating query pair samples based on said statistically frequent query pairs may comprise generating features for each query pair sample. In this embodiment, the linear regression model may further be based on the generated query pair features. Generating features for each query pair may comprise generating a Levenshtein edit distance, the number of segments, the number of tokens in common or the frequency of the rewrites.

An active learning algorithm is then utilized to select a plurality of the most informative query pairs. In one embodiment, the number of the most informative query pairs is limited by a predefined limit. In alternative embodiments, the most informative query pairs are sent to an editorial team for labeling. The labeling comprising determining if each query pair is a precise match, approximate match, marginal match or mismatch.

A linear regression model may then be generated based on the selected most informative query pairs. In a preferred embodiment, a real time user query may be received and rewrites associated with the real time user query may be retrieved. The retrieved rewrites may be ranked according to the generated linear regression model and in one embodiment advertisements may be provided corresponding to a subset of the ranked rewrites. In a preferred embodiment, the subset of ranked rewrites corresponds to the N highest ranked rewrites.

The present invention is further directed towards a system for generating a linear regression model based on statistically frequent query pairs. The system may comprise a network coupled to a plurality of client devices and a server. In a preferred embodiment, the server may comprise a query pair operator operable to generate a plurality of statistically frequent query pairs. In one embodiment, the query pair operator may be operable to retrieve user queries from a query log data store. In an alternative embodiment, the query pairs generated by the query pair operator are only generated if they are above a log-likelihood threshold.

The system further contains at least one substitution table operable to store the statistically frequent query pairs and a query sampler operable to generate query pair samples. In a preferred embodiment, generating query pair samples based on said statistically frequent query pairs may further comprise generating features for each query pair sample. The features generated may comprise a Levenshtein edit distance, the number of segments, the number of tokens in common or the frequency of the rewrites.

An active learning unit is provided that may be operable to select a plurality of most informative query pairs. In a preferred embodiment, the most informative query pairs are limited by a predefined limit. In alternative embodiments, the most informative query pairs may then be sent to an editorial unit for labeling. The labeling may comprise determining if each query pair is a precise match, approximate match, marginal match or mismatch.

The present invention further comprises a linear regression unit operable to generate a linear regression model based on the selected most informative query pairs. In an alternative embodiment, the linear regression model may be further based on the generated query pairs. The present invention may further comprise a model data store comprising the generated linear regression model.

In alternative embodiments, the present invention may receive a real time user query and retrieve associated rewrites stored within the substitution tables. The system further may rank the rewrites using the generated linear regression model stored within the model data store and provide advertisements corresponding to a subset of the ranked rewrites. In a preferred embodiment, the subset of the ranked rewrites may correspond to the N highest ranked rewrites.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating one embodiment of a system for generating a new query that is related to an original search query while allowing for the providing of subject matter selected from a small corpus of advertiser keywords.

FIG. 2 is a flow diagram illustrating one embodiment of a method for generating query pairs.

FIG. 3 is a flow diagram illustrating one embodiment of a method for utilizing an active learning algorithm to create a linear regression model.

FIG. 4 is a flow diagram illustrating one embodiment of a method for utilizing a linear regression model in a real time search environment.

### DETAILED DESCRIPTION OF THE PREFERRED EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

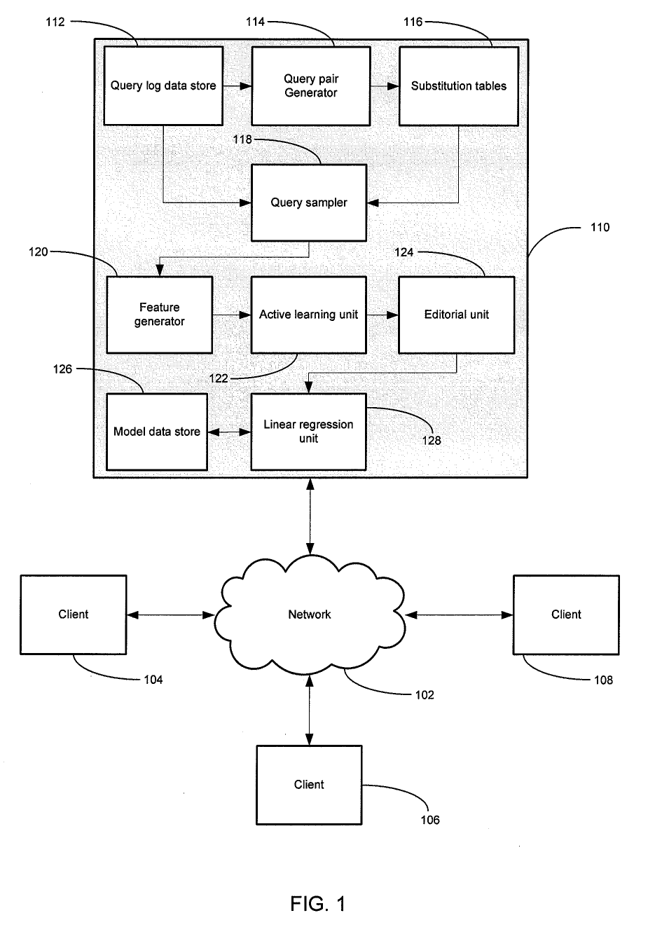

FIG. 1 presents a block diagram illustrating one embodiment of a system for generating a new query that is related to an original search query while allowing for the providing of subject matter selected from a small corpus of advertiser keywords. According to the embodiment illustrated in FIG. 1, a system comprises a plurality of client devices 104, 106 and 108, a server 110 coupled to a network 102.

According to the embodiment illustrated in FIG. 1, client devices 104, 106 and 108 are communicatively coupled to network 102, which may include a connection to one or more local and wide area networks, such as the Internet. According to one embodiment of the invention, client devices 104, 106 and 108 are general purpose personal computers comprising a processor, transient and persistent storage devices operable to execute software such as a web browser, peripheral devices (input/output, CD-ROM, USB, etc.) and a network interface. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Client devices 104, 106 and 108 are operative to communicate requests to server 110 via the network 102. A given request may be in the form of an HTTP request, RTP request, SOAP request, or in accordance with any other network protocol for requesting content as is known to those of skill in the art. In one embodiment, a client device 104, 106 and 108 may utilize a web browser to request a web page corresponding to the search results for one or more requested terms.

Server 110 comprises a query log data store 112. Query log data store 112 contains an accumulation of user queries, which may also comprise user selections from a corresponding result set. The user queries may be collected from monitoring the user of an Internet search engine; for example, by monitoring what query strings were entered into an HTML text box corresponding to the search input. Queries may be stored within query log data store 112 in a flat data file, relational database or any other storage means known in the art.

Query pair generator 114 is operative to select frequently sequential queries from the query log data store 112. Frequently occurring sequential query pairs correspond to query pairs that may have significant relevance to one another. For example, the queries “acoustic guitar” and “Martin guitar” may be determined to be a query pair containing two terms that relate to the same subject matter, in this instance, guitars. In accordance with one embodiment, a log-likelihood ratio threshold is utilized to determine the statistically frequent pairs. The log-likelihood test may correspond to Z-test, F-test, G-test or any other log-likelihood test known in the art.

Query pair generator 114 may be configured to limit the number of statistically frequent sequential pairs selected from the query log data store 112. In one embodiment, this number of pairs may be defined by a threshold that a given pair must surpass before being determined to be frequently occurring. Alternative embodiments may exist, however, wherein a fixed limit is defined as to how many query pairs may be selected from the query log data store 112. Alternatively, both mechanisms may be employed in conjunction with each other. That is, a maximum number of entries E may be defined, as well as a minimum threshold value T. When analyzing query log data store 112, query pair generator 114 may select one or more pairs with a log-likelihood ratio threshold higher than T and limit the amount of pair to a value of E. The statistically frequent rewrites are located within query log data store 112 and placed in substitution tables 116. Substitution tables 112 may comprise a flat data file, relational database or any other storage means known in the art.

Once the statistically frequent pairs are selected by query pair generator 114 and placed within substitution tables 116, query sampler 118 selects a sample of queries from query log data store 112. The sample size selected by query sampler 118 may be predetermined by the server. For example, a sample size of 20,000 queries may be determined to be an appropriate amount of data to successfully generate a linear regression model. Query sampler 118 is also communicatively coupled to substitution tables 116. Query sampler 118 iterates through the sample set of queries, as described previously, and finds the associated rewrites within the substitution tables 116. The resulting query/rewrite pairs represent the query pair sample set and are sent to feature generator 120.

Feature generator 120 is operative to receive a sample set of queries and associated rewrites from query sampler 118 and generate features for the pairs. A number of features may be extracted from the received query pairs including, but not limited to, Levenshtein edit distance, number of segments, number of tokens in common and the frequency of the rewrites.

The query rewrite pairs with associated features are transmitted to the active learning unit 122. The active learning unit 122 iterates through one or more of the received feature containing query rewrite pairs and selects the most informative pairs. In accordance with one embodiment, a maximum amount of query rewrite pairs is set within the active learning unit 122. For example, a limit in the range of 500-1000 query rewrite pairs may be set to limit the amount of data returned by the active learning unit 122 as well as prune the received list to a more manageable and more informative list.

The list of the most informative query rewrite pairs is transmitted to the editorial unit 124. The editorial unit 124 is operative to assign labels to the selected query pairs. Four labels are utilized to categorize the received query pairs: Precise Match, Approximate Match, Marginal Match and Mismatch. These correspond to scores 1, 2, 3 and 4, respectively. These scores are associated with the received query rewrite pairs and the query rewrite pairs/scores are sent to the linear regression unit 128. According to one embodiment, human editors interface with the editorial unit 124 to assign labels to the pairs.

Linear regression unit 128 is operative to receive the query pairs and scores and generate a linear regression model, as known in the art. The generated linear regression model is utilized to predict the relevance of an unlabeled query pair received by the server in response to future user queries. The type of linear regression utilized by the linear regression unit 128 may be selected by the server prior to execution. Linear regression techniques are well-known in the art, e.g. least squares analysis.

The linear regression unit generates the model for storage within a model data store 126. During operation, a user may submit a query via an HTML form element such as a text box. The search query is received by the server 110 and the associated rewrites are fetched from substitution tables 118. After fetching the rewrites from the substitution tables, the developed model stored within model data store 126 is utilized to rank the fetched rewrites.

In accordance with one embodiment, the ranked rewrites may be utilized to deliver advertisements related to the user query. A subset of the ranked rewrites may be selected from the output of the linear regression model; for example, the top five rewrites may be selected. The rewrites may be used to select relevant advertisements stored on the server 110 or external servers (not shown). Server 110 is operative to combine the retrieved advertisements with the search results that correspond to the user search query.

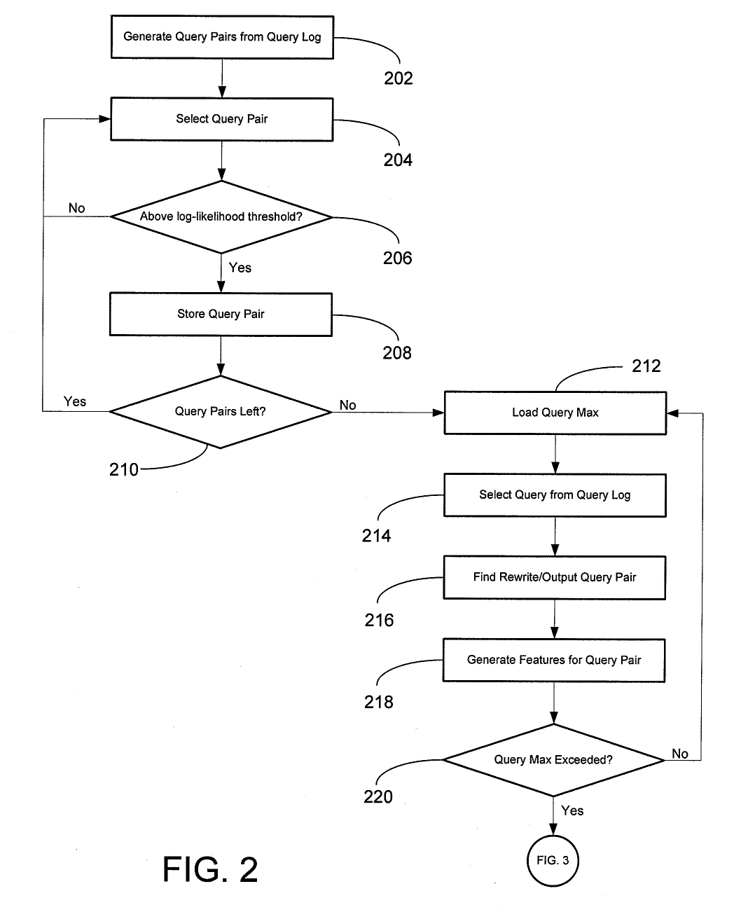

FIG. 2 presents a flow diagram illustrating one embodiment of a method for generating query pairs. According to the embodiment illustrated in FIG. 2, query pairs are generated from a query log, step 202. In accordance with one embodiment, a set of query pairs may correspond to the formula given in Equation 1:

$$\begin{matrix}candidateQueryPairs ( {user}_{i} , {day}_{j} ) = \\ \{ \begin{matrix}< {q}_{1} , {q}_{2} > : ( {q}_{1} \neq {q}_{2} ) ⋀ ∃ t {query}_{t} ( {user}_{i} , {q}_{1} ) ⋀ \\ {query}_{t + 1} ( {user}_{i} , {q}_{2} )\end{matrix} \}\end{matrix} \qquad Equation 1$$

That is, a query pair must satisfy the condition that the queries are not identical and the queries are successive queries occurring at time T and T+1.

The query pairs are generated, a query pair is selected (step 204) and a check is performed to determine if the selected query pair is above a log-likelihood threshold, step 206. As previously described, a log-likelihood threshold ratio is utilized to determine which of the query pairs are statistically frequent query pairs. Various log-likelihood tests may be utilized such as the Z-test, P-test, G-test or any other log-likelihood test known in the art. For example, a query pair consisting of (q1,q2)=(“martin guitar”, “acoustic guitar”) may be above a predetermined threshold as “martin guitar” specifies a specific brand of “acoustic guitar” and may be considered frequently occurring. However, a query pair consisting of (q₃,q₄)=(“acoustic guitar”, “used car”) may be considered below a predetermined threshold as the two queries are related to differing subject matter with little, if any, overlap.

If a query pair is determined to be below the predetermined log-likelihood threshold, it is unlikely that the query pair is a frequently recurring pair and is discarded. Subsequently, the next query pair is examined, step 204. However, if the query pair is above the predetermined threshold it is likely that the query pair may be a frequently recurring pair and the query pair is stored, step 208.

A second check is performed to determine if query pairs remain to be compared to the log-likelihood threshold, step 210. If query pairs remain, the remaining query pairs are examined, steps 204-210. If not, a sample set of queries are extracted from a query log, steps 212-220.

After the statistically determined frequently occurring query pairs are determined in steps 202-210, a query maximum is generated, step 212. The generated query maximum corresponds to the maximum number of accumulated user queries that are to be analyzed. A query is then selected from the list of queries within the query log, step 214. Queries may be chosen at random from the query log, although alternative embodiments exist wherein a selection algorithm is utilized to intelligently select queries from the query log.

The query is selected from the query log and a lookup is performed to determine if the rewrite exists in the query pair storage (created in step 208), step 216. Continuing the previous example, a query pair (“martin guitar”, “acoustic guitar”) may exist within the query pair storage. If the query selected from the query log corresponds to “martin guitar” the query pair (“martin guitar”, “acoustic guitar”) may be selected from the query pair storage.

Upon locating the query rewrite pair in the query pair storage, features are generated for the located query rewrite pair, step 218. Features generated for a query rewrite pair may comprise Levenshtein edit distance, number of segments, number of tokens in common, the frequency of the rewrites or any other features of query pairs known in the art. The generated features are then associated with the query rewrite pair.

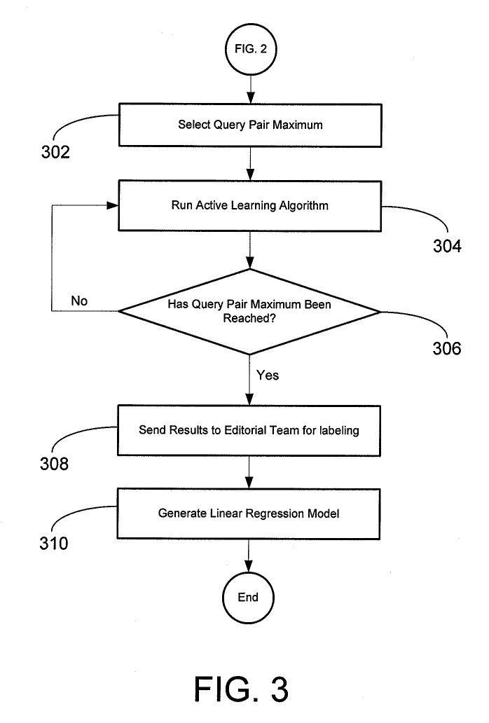

If the query maximum has not been exceeded (step 220), a next query is selected from the historical query log and the steps 214-218 are performed for the next query. If the query maximum has been reached (step 220), the process proceeds, as is described with respect to FIG. 3.

FIG. 3 presents a flow diagram illustrating one embodiment of a method for utilizing an active learning algorithm to create a linear regression model. A query pair maximum is selected, step 302. The query maximum may be determined by the server to comprise the most informative query pairs. A range of value for the query maximum is on the order of 500-1000 query pairs.

After a query maximum is set, an active learning algorithm is run to select the most informative query pairs provided as input, step 304. Active learning algorithms have the advantage of allowing a system to “teach” itself, which significantly reduces workload while, when implemented properly, maximizes the quality of the results. The choice of active learning methods is primarily dependent on the learning model utilized. In one embodiment, the learning model utilized by the system is based on regression framework. Regression analysis determines the strengths of a relationship between dependent variables and independent variables (also known as response variables and predictors).

The active learning method continues to run until the query pair maximum has been reached. If a query pair maximum has not been reached (step 306), the active learning algorithm continues to execute. As stated before, the query pair maximum is the value of the number of relevant query pairs to extract. If a query pair maximum has been reached, the results of the active learning algorithm are sent to an editorial team for labeling, step 308.

The editorial team receives the statistically frequent query pairs selected from the active learning algorithm and proceeds to score the pairs. An example scoring table is shown in Table 1.

TABLE 1

| Score | Type | Definition | Example |
|---|---|---|---|
| 1 | Precise Match | A near-certain match. | Automotive |
| | | | insurance - |
| | | | automobile |
| | | | insurance |
| 2 | Approximate Match | A probable, but inexact | Hybrid car - |
| | | match with user intent | Toyota Prius |
| 3 | Marginal Match | A distant, but plausible | IBM Thinkpad - |
| | | match to a related topic | laptop bag |
| 4 | Mismatch | A clear mismatch | Time magazine - |
| | | | time and |
| | | | date magazine |

The editorial team is labels the results generated by the active learning algorithm and a linear regression model is generated on the basis of the labeled pairs, step 310. The generated linear regression model is utilized to predict the relevance of any query pair received by the server in future user queries. As stated previously, linear regression models are well known in the art and are not described fully in this application.

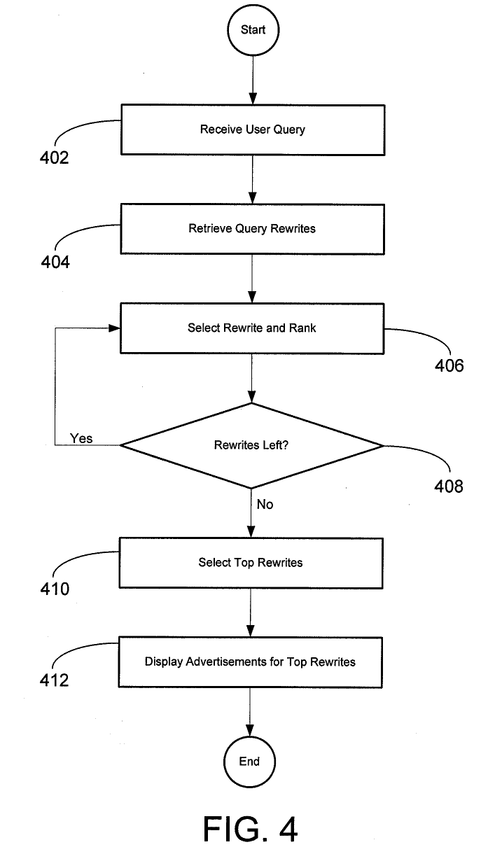

FIG. 4 presents a flow diagram illustrating one embodiment of a method for utilizing a linear regression model in a real time search environment. FIG. 4 illustrates a one embodiment for dynamically determining rewrites of real time user queries using a previously generated linear regression model. First, a user query is received, step 402. A user query may comprise a search term submitted by a user via an HTML form or similar mechanism. The search term may be submitted in the process of a user requesting search results from a search engine. For example, a user may enter the term “Martin guitar” into a search engines HTML text box and submit the form for processing by the search engine server.

Query rewrites corresponding to the user query are retrieved, step 404. In a one embodiment, the query rewrites correspond to the query rewrites stored in FIG. 2. Continuing the previous example of a user searching for the term “Martin guitar”, a look up may be performed to determine the relevant query rewrites previous stored by the present invention. A query rewrite match may exist and may associate the search term “Martin guitar” with the queries “acoustic guitar” and “guitar”. Although only two query rewrites are shown in the present example, those of skill in the art recognize that the number of query rewrites is not limited to only two rewrites. In one embodiment, the number of retrieved rewrites corresponding to a user query may be unlimited. In alternative embodiments, the number of retrieved rewrites corresponding to a user query may be limited by a predetermined limit. For example, if it is known that a maximum of five rewrites are to be used, the number of rewrites retrieved for a user query may be limited to five to reduce processing time.

A rewrite is selected from the plurality of retrieved rewrites, step 406. After the rewrite is selected, it is ranked using the developed linear regression model (step 406). A check is performed to determine whether any rewrites remain in the selected list of corresponding rewrites, step 408. If rewrites remain, process returns to step 406.

If no rewrites are remaining to be ranked, the top rewrites are selected, step 410. The selection of the number of top rewrites may be determined by the server. An example of this embodiment would correspond to an advertisement server allocating data to a limited number of “slots” on a search result page. As previously mentioned, sponsored search advertising comprises filling advertisement positions on a search result page. This methodology imposes limits to the number of advertisements and thus advertisements slots present on a given search result page. For example, if a limit of three advertisements exists for a given search result page (corresponding to top, side and bottom slots), a limit of three top rewrites may be utilized to select the top rewrites.

After a subset of the ranked rewrites corresponding to the top rewrites is selected in step 410, advertisements are selected and displayed for the selected subset, step 412. Query rewrites may be utilized to index an advertisement store containing advertisements corresponding to bid on keywords. For example, the top rewrites may be utilized to determine which advertisements to be displayed based on advertiser bid information [CROSS REFERENCE TO POSITION AUCTION APP?].

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for generating a linear regression model based on statistically frequent query pairs, the method comprising:
storing statistically frequent query pairs, said query pairs constituting a query and a query rewrite;
generating query pair samples based on said statistically frequent query pairs;
utilizing an active learning algorithm to select a plurality of most informative query pairs; and
generating a linear regression model based on the selected most informative query pairs.

2. The method of claim 1 wherein said query pairs are generated from a log of accumulated user queries.

3. The method of claim 1, wherein storing statistically frequent query pairs is based on determining if a query pair is above a log-likelihood threshold.

4. The method of claim 1, wherein generating query pair samples comprises selecting a predetermined amount of queries from a query log and locating the associated rewrites within stored statistically frequent query pairs.

5. The method of claim 1, wherein generating query pair samples based on said statistically frequent query pairs further comprises generating features for each query pair sample.

6. The method of claim 5, wherein generating features for each query pair sample comprises generating a Levenshtein edit distance, the number of segments, the number of tokens in common or the frequency of the rewrites.

7. The method of claim 1, wherein the number of the most informative query pairs is limited by a predefined limit.

8. The method of claim 1, wherein the most informative query pairs are sent to an editorial team for labeling.

9. The method of claim 8, wherein said labeling comprises determining if each query pair is a precise match, approximate match, marginal match or mismatch.

10. The method of claim 5, wherein said linear regression model is further based on the generated query pair features.

11. The method of claim 1 further comprising receiving a real time user query.

12. The method of claim 11 further comprising retrieving said real time user queries associated rewrites.

13. The method of claim 12 further comprising ranking said rewrites using said linear regression model.

14. The method of claim 13 further comprising providing advertisements corresponding to a subset of said ranked rewrites.

15. The method of claim 14, wherein said subset of said ranked rewrites corresponds to the N highest ranked rewrites.

16. A system for generating a linear regression model based on statistically frequent query pairs comprising:
a network;
a plurality of client devices coupled to said network;
a server coupled to said network, said server comprising:
a query pair operator operable to generate a plurality of statistically frequent query pairs;
at least one substitution table operable to store said statistically frequent query pairs;
a query sampler operable to generate query pair samples;
an active learning unit operable to select a plurality of most informative query pairs;
a linear regression unit operable to generate a linear regression model based on the selected most informative query pairs; and
a model data store containing a said linear regression model

17. The system of claim 16 wherein said query pair operator is operable to retrieve user queries from a query log data store.

18. The system of claim 16, wherein said query pairs are only generated if above a log-likelihood threshold.

19. The system of claim 16, wherein generating query pair samples based on said statistically frequent query pairs further comprises generating features for each query pair sample.

20. The system of claim 19, wherein generating features for each query pair sample comprises generating a Levenshtein edit distance, the number of segments, the number of tokens in common or the frequency of the rewrites.

21. The system of claim 16, wherein the number of the most informative query pairs is limited by a predefined limit.

22. The system of claim 16, wherein the most informative query pairs are sent to an editorial unit for labeling.

23. The method of claim 22, wherein said labeling comprises determining if each query pair is a precise match, approximate match, marginal match or mismatch.

24. The system of claim 20, wherein said linear regression model is further based on the generated query pair features.

25. The system of claim 16, further comprising receiving a real time user query.

26. (canceled)

27. (canceled)

28. (canceled)

29. (canceled)
